(19) United States
(12) Patent Application Publication
(10) Pub. No.: US 2006/0095731 A1
(43) Pub. Date: May 4, 2006

(54) Method and apparatus for avoiding read port assignment of a reorder buffer

(76) Inventors: Yuval Bustan, Moshav Mismeret (IL); Asi Joseph, Kiryat Motzkin (IL); Guillermo Savransky, Haifa (IL); Zeev Sperber, Zichron Yaakov (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/932,088

(22) Filed: Sep. 2, 2004

(51) Int. Cl. G06F 9/30

(52) U.S. Cl. 712/217; 712/218

(57) ABSTRACT

An out-of-order subsystem of a processor includes a register alias table and allocation (RAT/ALLOC) unit, a reservation station (RS) and a reorder buffer (ROB). Destination identifiers of one or more execution results that are not yet stored in any register file of the ROB may be compared to source identifiers of operands of micro-operations that are being issued to the RS. Each execution result corresponding to a destination identifier that matches one of the source identifiers is retrieved from a data path external to the ROB and routed to an appropriate port of the RS for an operand corresponding to the source identifier so that the RAT/ALLOC unit does not need to allocate a read port of the ROB for the RS to read the execution result.

### BACKGROUND OF THE INVENTION

Processors may include different types of execution units (EU), each dedicated and optimized for performing specific tasks. A non-exhaustive list of examples for an execution unit includes an integer EU for manipulating operands in integer format, a floating point EU for manipulating operands in floating point format, a jump EU for executing program branches, a barrel shifter EU, a multiplier EU, an arithmetic logic unit (ALU) EU, a multimedia EU for performing specific multimedia and communication instructions, such as, for example, Multi Media extensions (MMX™) instructions, and the like. Moreover, processors may also have more than one EU of each type. A processor having several EUs may be able to operate each EU independently and consequently will be able to execute several micro-operations in parallel.

A processor having more than one execution unit may employ out-of-order techniques in order to use the execution units in an efficient manner. An instruction in a system memory, when processed by the processor, is decoded into one or more micro-operations (“u-ops”). Each u-op is to be executed by an out-of-order subsystem of the processor. The out-of-order subsystem enables more than one u-op to be executed at the same time, although the u-ops may be executed in a different order than the order in which they were received by the out-of-order subsystem.

A processor having an out-of-order subsystem may include a set of architectural registers for storing execution results of u-ops in the order in which the u-ops were received by the out-of-order subsystem (storing the execution result of a u-op in an architectural register is called “retiring” the u-op). In addition, the out-of-order subsystem may include a set of temporary registers for storing execution results until such time as those results may be stored in the architectural registers.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 is a block diagram of an apparatus having a processor according to an embodiment of the invention, the processor having an out-of-order subsystem that has a reservation station and a reorder buffer; and

FIG. 2 is a combined flowchart and timing diagram of an exemplary method, to provide a reservation station with allocated execution results that are stored or are to be stored in a register file of an out-of-order subsystem of a processor, according to some embodiments of the invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF THE INVENTION

In the following detailed description, numerous specific details are set forth in order to provide a thorough understanding of embodiments of the invention. However it will be understood by those of ordinary skill in the art that the embodiments of the invention may be practiced without these specific details. In other instances, well-known methods, procedures, components and circuits have not been described in detail for clarity.

Embodiments of the invention may be used in any apparatus having a processor. For example, the apparatus may be a portable device that is powered by a battery. A non-exhaustive list of examples of such portable devices includes laptop and notebook computers, mobile telephones, personal digital assistants (PDA), and the like. Alternatively, the apparatus may be a non-portable device, such as, for example, a desktop computer or a server computer.

Execution results that are produced by execution units of a processor may be stored in files of architectural or temporary registers in a reorder buffer of an out-of-order (OOO) subsystem of a processor. On allocation of such registers as operands to other micro-instructions, the execution results may be routed from the registers, through read ports of the reorder buffer, to a reservation station of the processor. In some processors, addressing read ports of a reorder buffer may consume a relatively high power. In addition, the read port assignment resolution may be time consuming if override of in-flight register is performed.

According to some embodiments of the invention, execution results that are required at the reservation station as operands to other micro-instructions and that are not yet stored in any register file of the reorder buffer, may be routed to the reservation station from a data path external to the reorder buffer, thus eliminating the need to assign a read port of the reorder buffer for the reservation station to retrieve these execution results.

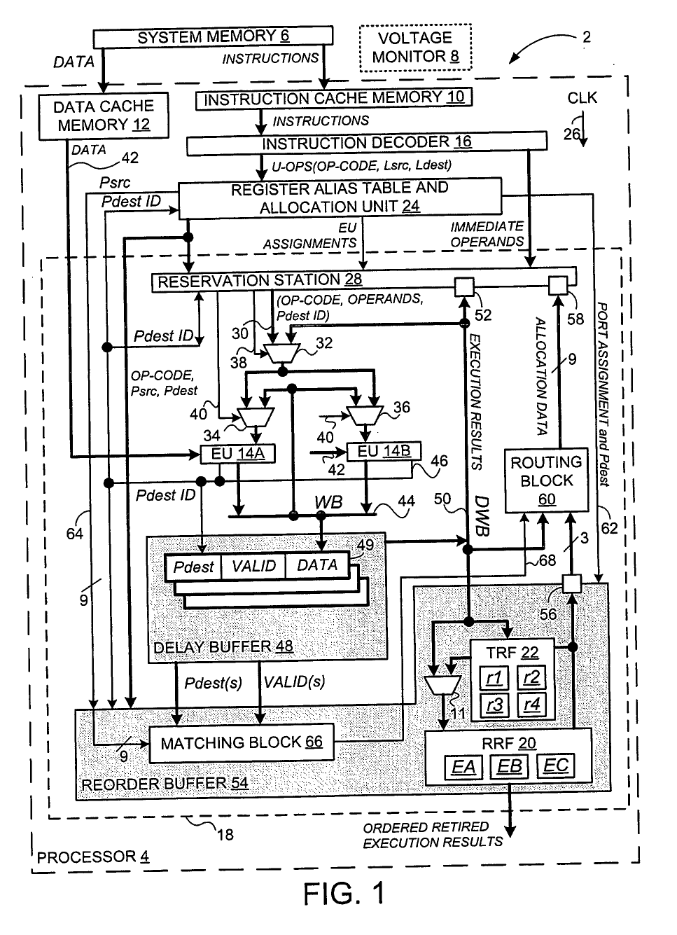

As shown in FIG. 1, an apparatus 2 may include a processor 4 and a system memory 6, and may optionally include a voltage monitor 8. Well-known components and circuits of apparatus 2 and of processor 4 are not shown in FIG. 1 for clarity.

Design considerations, such as, but not limited to, processor performance, cost and power consumption, may result in a particular processor design, and it should be understood that the design of processor 4 shown in FIG. 1 is merely an example and that embodiments of the invention are applicable to other processor designs as well.

A non-exhaustive list of examples for processor 4 includes a central processing unit (CPU), a digital signal processor (DSP), a reduced instruction set computer (RISC), a complex instruction set computer (CISC) and the like. Moreover, processor 4 may be part of an application specific integrated circuit (ASIC) or may be part of an application specific standard product (ASSP).

A non-exhaustive list of examples for system memory 6 includes a dynamic random access memory (DRAM), a synchronous dynamic random access memory (SDRAM), a flash memory, a double data rate (DDR) memory, RAMBUS dynamic random access memory (RDRAM) and the like. Moreover, system memory 6 may be part of an application specific integrated circuit (ASIC) or may be part of an application specific standard product (ASSP).

System memory 6 may store instructions to be executed by processor 4. Instructions retrieved from system memory 6 may be stored temporarily in an instruction cache memory 10 of processor 4. System memory 6 may also store data for the instructions, or the data may be stored elsewhere. Data for the instructions retrieved from system memory 6 or elsewhere may be stored temporarily in a data cache memory 12 of processor 4.

Processor 4 may comprise several EUs 14, although for clarity of the explanation, only two EUs, denoted 14A and 14B, are shown. Processor 4 may employ out-of-order techniques in order to use EUs 14 in an efficient manner.

An instruction decoder (ID) 16 may decode an instruction into one or more micro-operations (“u-ops”) depending on the type of instruction or according to some other criterion. Each u-op may be executed by an out-of-order subsystem 18 of the processor. OOO subsystem 18 enables more than one u-op to be executed at the same time, although the u-ops may be executed in a different order than the order in which they were received by OOO subsystem 18.

OOO subsystem 18 may include a real register file (RRF) 20 having a set of architectural registers for storing execution results of u-ops in the order in which the u-ops were received by OOO subsystem 18 (storing the execution result of a u-op in an architectural register is called “retiring” the u-op). The architectural registers of RRF 20 may include, for example, three architectural register denoted EA, EB and EC, although RRF 20 may include any other architectural registers.

OOO subsystem 18 may include a temporary register file (TRF) 22 having a set of temporary registers for storing execution results until such time as those results may be stored in the architectural registers. The temporary registers of TRF 22 may include, for example, four temporary registers denoted r1, r2, r3 and r4, although TRF 22 may include any other temporary registers.

The Register Alias Table and Allocation Unit

A u-op may include an “op-code”, may optionally include one or more “logical sources” (Lsrc), may optionally include one or more immediate operands, and may optionally include one “logical destination” (Ldest). An op-code is a field of the u-op that defines the type of operation to be performed on operands of the u-op. An immediate operand is an operand that is embedded in the u-op, and a logical source is an identifier of an architectural register where an operand is to be found. A logical destination is an identifier of an architectural register to receive and store the execution result of the u-op once the u-op is retired.

Processor 4 may include a register alias table and allocation unit (RAT/ALLOC) 24. RAT/ALLOC 24 may receive u-ops from ID 16, and may “allocate” physical destinations (Pdest) in OOO subsystem 18 to store the execution results of the u-ops until the results are retired. Physical destinations may be, for example, temporary registers of TRF 22 or architectural registers of RRF 20.

In addition, RAT/ALLOC 24 may identify physical sources in OOO subsystem 18 that store values that are needed as operands to the u-ops. RAT/ALLOC 24 may “rename” logical sources of the u-op with identifiers of the physical sources (Psrc). Physical sources may be, for example, temporary registers of TRF 22 and/or architectural registers of RRF 20.

Moreover, RAT/ALLOC 24 may assign for each renamed/allocated u-op which of EU(s) 14 is to execute the op-code.

For example, a u-op decoded by ID 16 may have the following exemplary general form:

u-op (1): Ldest←op-code,Lsrc1,Lsrc2, IM

Lsrc1 and Lsrc2 are logical-sources, and IM is an immediate operand. In exemplary decoded u-op (2), architectural register EA is a logical destination, in which the sum of the values stored in the logical sources EA and EB is to be stored.

u-op (2): EA←add ,EA ,EB

In one example, prior to execution of u-op (2), RAT/ALLOC 24 may identify that in OOO sub-system 18, the most updated value of architectural register EA is stored in, for example, temporary register r4, and that the most updated value of architectural register EB is stored in, for example, temporary register r2. RAT/ALLOC 24 may rename the logical source EA to the physical source r4, and may rename the logical source EB to the physical source r2.

In addition, RAT/ALLOC 24 may identify that temporary register r3 can be used to receive the execution result of u-op (2), and may allocate temporary register r3 as a physical destination of u-op (2). After allocation and renaming, u-op (2) may have the following structure:

Renamed/Allocated u-op (3): r3←add ,r4,r2

In another example, prior to execution of u-op (2), RAT/ALLOC 24 may identify that in OOO sub-system 18, the most updated value of architectural register EA is stored in architectural register EA. RAT/ALLOC 24 may rename the logical source EA to the physical source EA, and after allocation and renaming, u-op (2) may have the following structure:

Renamed/Allocated u-op (4): r3←add ,EA ,r2

At each cycle of a clock 26, ID 16 may receive, at most three instructions from instruction cache memory 10 and may output at most three u-ops from previously received instructions. At each cycle of clock 26, RAT/ALLOC 24 may receive at most three u-ops from ID 16 and may output to OOO subsystem 18 at most three renamed/allocated u-ops and their corresponding EU assignments. (In other embodiments, the limit of instructions received by the instruction decoder per clock cycle from the instruction cache memory may be other than three. Similarly, in other embodiments, the limit of u-ops output by the instruction decoder per clock cycle may be other than three. In other embodiments, the limit of u-ops received by the RAT/ALLOC per clock cycle from the instruction decoder may be other than three. Similarly, in other embodiments, the limit of renamed/allocated u-ops and corresponding EU assignments output by the RAT/ALLOC per clock cycle to OOO subsystem 18 may be other than three.)

The Reservation Station

OOO subsystem 18 may include a reservation station (RS) 28 that, at each cycle of clock 26, may receive from RAT/ALLOC 24 and store internally at most three renamed/allocated u-ops and their EU assignments. (In other embodiments, the limit of renamed/allocated u-ops received by RS 28 per clock cycle may be other than three). In addition RS 28 may receive immediate operands from ID 16.

RS 28 may include a port 52 to receive operands that are execution results of other u-ops, from execution units 14 or from elsewhere.

RS 28 may also include several ports 58, for example, nine ports 58, to receive operands on allocation from TRF 22, RRF 20, or from elsewhere.

RS 28 may dispatch a u-op to an assigned EU via signals 30 and various routing multiplexers. A u-op dispatched by RS 28 may contain an op-code, operands and an identifier of the physical destination of the renamed/allocated u-op. RS 28 may select an assigned EU according to, for example, the EU assignments received from RAT/ALLOC 24 and/or according to other criteria, if any.

For example, RS 28 may dispatch a u-op to EU 14A through a MUX 32 and a MUX 34, and to EU 14B through MUX 32 and a MUX 36. RS 28 may control MUX 32 via signals 38 and may control MUX 34 and MUX 36 via signals 40.

The assigned EU may receive the dispatched u-op, may optionally receive data for the u-op from data cache memory 12 over, for example, signals 42, and may execute the dispatched u-op. The assigned EU may output the execution result of the u-op on a write-back (WB) bus 44, and may output the Pdest identifier of the u-op on signals 46. Execution units 14 may output the Pdest identifier on signals 46, for example, two cycles of clock 26 before outputting the execution result on WB bus 44.

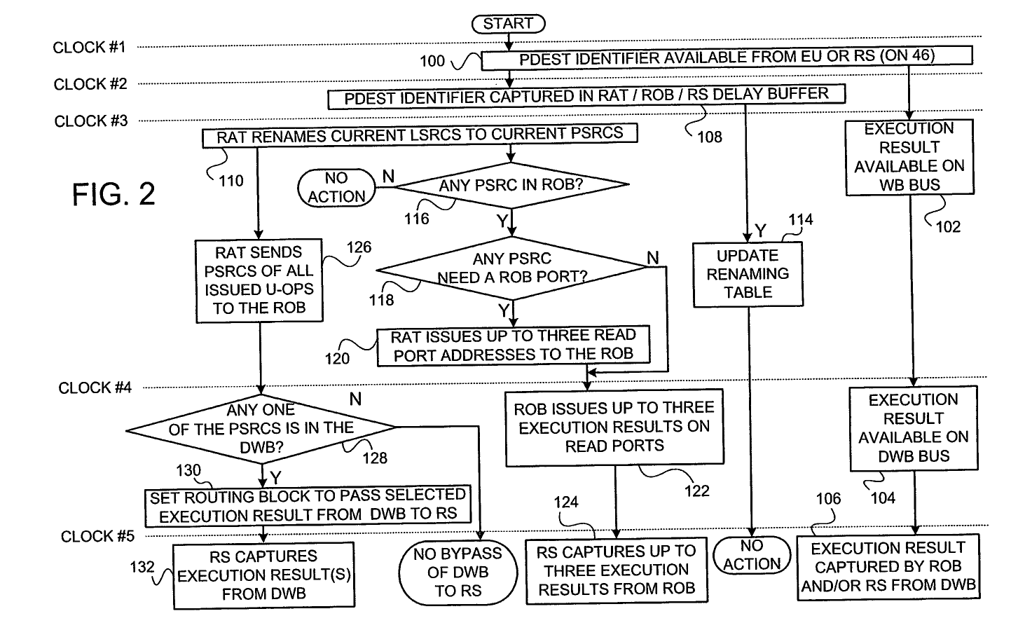

Reference is now made in addition to FIG. 2, which is a combined flowchart and timing diagram of an exemplary method, to provide RS 28 with allocated execution results that are stored or are to be stored in RRF 20 and/or TRF 22, according to some embodiments of the invention.

In FIG. 2, five consecutive cycles of clock 26 are presented. The five consecutive cycles of clock 26 are denoted “clock #1” to clock #5”, according to their order in time. The dotted lines represent active edges of “clock #1” to clock #5”, in which operations occur in OOO subsystem 18.

As shown in FIG. 2, EU 14, or RS 28, may output a Pdest identifier on signals 46 (100) at the active edge of “clock #1”, and EU 14 outputs the execution result on WB bus 44 (102) at the active edge of “clock #3”.

OOO subsystem 18 may include a delay buffer 48, to receive execution results and their corresponding Pdest identifiers via WB bus 44 and signals 46, respectively, and to store the execution results and their corresponding Pdest identifiers for at least one cycle of clock 26 in one of entries 49. Entries 49 may include a “valid” field to mark entries 49 that contain valid Pdest identifiers. A Pdest identifier may be valid in delay buffer 48 from the moment it is written into an entry 49 until the corresponding execution result is written into RRF 20 and/or TRF 22.

Delay buffer 48 may output a delayed-write-back (DWB) bus 50, and execution results stored in delay buffer 48 may be present on DWB bus 50 one or more cycles of clock 26 after the execution results are presented on write-back bus 44.

For clarity of the explanation, in the particular example shown in FIG. 2, DWB bus 50 is delayed by one cycle of clock 26 from write-back bus 44, and therefore, the execution result is outputted onto DWB bus 50 after the active edge of “clock #4” (104). However, the invention is not limited in this respect, and delay buffer 48 may delay execution results for more than one cycle of clock 26, and may delay different execution results with different numbers of cycles of clock 26.

A particular u-op may be “valid-for-dispatching” from RS 28 once all of the operands of the particular u-op are available to be dispatched to the assigned EU. RS 28 may receive Pdest identifiers of execution results from EUs 14 via signals 46, and may identify whether a particular execution result is an operand to a particular u-op that is not yet dispatched. RS 28 may dispatch a valid-for-dispatching u-op while routing operands to the assigned EU from where the operands are available.

In one example, RS 28 may identify that an execution result on WB bus 44 is required as an operand to EU 14A, and that any other criteria for dispatching the u-op to EU 14A are satisfied. RS 28 may dispatch the u-op to EU 14A while routing the execution result from WB 44 to EU 14A through MUX 34.

In another example, RS 28 may identify that an execution result on DWB bus 50 is required as an operand to EU 14B, and that any other criteria for dispatching the u-op to EU 14B are satisfied. RS 28 may dispatch the u-op to EU 14B while routing the execution result from DWB 50 to EU 14B through MUX 36.

In yet another example, RS 28 may identify that an execution result on DWB bus 50 is required as an operand to EU 14B, while other criteria for dispatching the u-op to EU 14B are not yet satisfied. RS 28 may receive the execution result from DWB 50 through port 52 and may capture the execution result on the active edge of “clock #5” (106). RS 28 may store the execution result internally until the u-op is valid for dispatching. Once the u-op becomes valid for dispatching, RS 28 may dispatch the u-op to EU 14B.

RS 28 may dispatch a u-op to an assigned EU only if certain resources are available and any other conditions, if any, are met. A non-exhaustive list of the resources RS 28 may check for availability includes the assigned EU(s), signals 30, WB bus 44 and optionally DWB bus 50. RS 28 may check that the assigned EU is available to execute the op-code of the particular u-op, that signals 30 have the capacity to carry the op-codes, operands and the Pdest identifier of the particular u-op, and that WB bus 44 and optionally DWB bus 50 will be available to carry the execution results of the particular u-op once the results are calculated.

RS 28 may store and handle more than one u-op at a time. The conditions for execution of one u-op may be fulfilled before the conditions for execution of a u-op that was received earlier. Consequently, u-ops may be dispatched and executed in an order that may be different from the order in which they were received by OOO subsystem 18.

The Reorder Buffer

OOO subsystem 18 may include a reorder buffer (ROB) 54, and TRF 22 and RRF 20 may be included in ROB 54. ROB 54 may receive the allocated u-ops from RAT 24 in the same order that they are sent to RS 28, and may store the allocated u-ops in a queue. Entries in the queue may be associated with temporary registers of TRF 22.

ROB 54 may receive execution results from DWB 50 and may capture the execution results on the active edge of “clock #5” (106). In addition, ROB 54 may receive the Pdest identifiers of the corresponding u-ops via signals 46, and may capture the Pdest identifiers on the active edge of “clock #2” (108).

WB bus 44, delay buffer 48 and DWB bus 50 may be collectively referred to as a “data path” that connects outputs of EU(s) 14 to inputs of RRF 20 and TRF 22. It may be appreciated that other architectures of a data path that connects outputs of EU(s) 14 to inputs of RRF 20 and TRF 22 are possible, and are covered by the invention.

ROB 54 may store the execution results in the physical destinations at TRF 22 pointed out by the Pdest identifiers until the u-ops are retired to RRF 20.

A particular u-op is “valid-for-retiring” if its execution results are available for retiring and other conditions, if any, have been satisfied. ROB 54 may then retire the valid-for-retiring u-ops according to the original order of u-ops and may store their execution results in the architectural registers of RRF 20.

For example, an execution result to be retired may be stored in TRF 22, and ROB 54 may retire the execution result from TRF 22 to RRF 20 via a MUX 11. Alternatively, an execution result to be retired may be stored in delay buffer 48, and ROB 54 may retire the execution result from delay buffer 48 to RRF 20 via MUX 11.

At each cycle of clock 26, ROB 54 may retire at most three “valid for retiring” u-ops. (In other embodiments, the limit of u-ops retired by ROB 54 per clock cycle may be other than three.) No u-ops will be retired until the u-op that is next to be retired according to the original order of u-ops is valid-for-retiring.

As previously described, RS 28 may monitor signals 46 for Pdest identifiers of execution results, may control routing of execution results back to the EU(s) if required, and/or may control capturing the execution results as operands for to-be-dispatched u-ops EU(s) 14.

In addition, RS 28 may receive operands for to-be-dispatched u-ops from TRF 22 and/or RRF 20 under control, at least in part, of RAT/ALLOC 24. ROB 54 may have, for example, three read ports 56 through which, at most three execution results stored in TRF 22 and/or RRF 20 can be sent to RS 28 in one cycle of clock 26. A routing block 60 may route at most three execution results from read ports 56 to input ports 58.

For at least renaming and allocating u-ops, RAT/ALLOC 24 may monitor OOO subsystem 18, and in particular, may monitor signals 46, and may be capable of resolving sources of execution results in RRF 20 and TRF 22 for cycles of interest of clock 26.

RAT/ALLOC 24 may capture Pdest identifiers from signals 46 on the active edge of “clock #2” (108), and on the active edge of “clock #3”, RAT/ALLOC 24 may perform renaming of logical sources of u-ops into physical sources (110).

On the active edge of “clock #3”, RAT/ALLOC 24 may update internal renaming table(s) (not shown) (114). Moreover, on the active edge of “clock #3”, RAT/ALLOC 24 may check if at least one of the physical sources resulting from box (110) is already in TRF 22 and/or RRF 20 (116).

If so, and if any of the physical sources requires a read port 56 to be sent to RS 28 (118), RAT/ALLOC 24 may issue addresses of read ports 56 to ROB 54 via signals 62 (120). ROB 54 may receive the addresses from signals 62, and on the active edge of “clock #4”, ROB 54 may output at most three execution results through read ports 56 to RS 28 (122). On the active edge of “clock #5”, RS 28 may capture the execution results from input ports 58 (124).

The parts of the method described in boxes 116, 118, 120, 122 and 124, deal with fetching execution results from ROB 54 to RS 28 during allocation of a u-op. Another part of the method, described hereinbelow in boxes 126, 128, 130 and 132, also deals with sending execution results to RS 28 during allocation of a u-op. However, in the parts of the method that are described in boxes 116, 118, 120, 122 and 124, execution results that are not yet stored in TRF 22 and/or RRF 20, may be routed from delay buffer 48 to RS 28 without being previously stored in TRF 22 and/or RRF.

On the active edge of “clock #2”, delay buffer 48 may capture Pdest identifiers from signals 46 (108), and as previously described, execution results and their corresponding Pdest identifiers may be outputted by delay buffer 48 into DWB bus 50 after the active edge of “clock #4” (104).

On the active edge of “clock #3”, RAT/ALLOC 24 may output a list of identifiers of all the Psrcs of issued u-ops via signals 64 (126). The list may comprise, for example, nine Psrc identifiers.

During “clock #4”, a matching block 66, that may be included in ROB 54, may compare the Psrcs identifiers received via signals 64 to all the valid Pdest values that are stored in delay buffer 48. If one or more of the valid Pdest identifiers that are stored in delay buffer 48 matches Psrc identifiers that were received via signals 64 (128), matching block 66 may send controls 68 to routing block 60 to receive the corresponding execution results from delay buffer 48 and to route the corresponding execution results from DWB bus 50 to respective input ports 58 (130).

For example, in box (128) matching block 66 may find that three execution results can be retrieved from delay buffer 48 for allocation, and may accordingly control routing block 60 to route the matching execution results from delay buffer 48 to input ports 58.

On the active edge of “clock #5”, RS 28 may capture the execution results from DWB bus 50 (132). Execution result that is captured by RS 28 in box (132) or in box (124) may be marked as valid in RS 28.

It may be appreciated that according to the method of FIG. 2, RS 28 can receive on the active edge of “clock #5” at most three execution results from ROB 54 through ports 58, and additional execution results from delay buffer 48.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method in an out-of-order subsystem of a processor, said out-of-order subsystem including a register alias table and allocation unit, a reservation station and a reorder buffer, the method comprising:
comparing destination identifiers of one or more execution results that are not yet stored in any register file of said reorder buffer to source identifiers of one or more operands of micro-operations that are being issued to said reservation station by said register alias table and allocation unit,
wherein a destination identifier specifies a physical destination in said reorder buffer that is allocated for storage of an execution result, and a source identifier specifies a physical source in said reorder buffer where an operand is eventually to be found.

2. The method of claim 1, further comprising:
routing each execution result corresponding to a destination identifier that matches one of said source identifiers to an appropriate port of said reservation station for an operand corresponding to said one of said source identifiers, wherein said execution result is retrieved from a data path coupling outputs of execution units to said reorder buffer so that said register alias table and allocation unit does not need to allocate a read port of said reorder buffer for said reservation station to read said execution result.

3. The method of claim 2, wherein said data path includes a delay buffer, and routing said execution result from said data path to said appropriate port further comprises:
routing said execution result from said delay buffer to said appropriate port.

4. The method of claim 3, wherein said destination identifiers are stored in said delay buffer together with said execution results, and comparing said destination identifiers to said source identifiers further includes:
comparing said destination identifiers from locations in said delay buffer to said source identifiers.

5. The method of claim 2, further comprising:
storing said execution result in said reservation station; and
storing said execution result in said register file.

6. The method of claim 5, wherein storing said execution result in said reservation station further comprises:
storing said execution result in said reservation station while storing said execution result in said register file.

7. The method of claim 5, further comprising:
marking said execution result as valid at said reservation station.

8. A processor comprising:
a reservation station;
a register alias table and allocation unit to issue micro-operations to said reservation station and to provide source identifiers of one or more operands of said micro-operations to said reservation station;
one or more execution units to provide execution results and corresponding destination identifiers; and
a reorder buffer including a matching block to compare destination identifiers of one or more of said execution results that are not yet stored in any register file of said reorder buffer to said source identifiers,
wherein a destination identifier specifies a physical destination in said reorder buffer that is allocated for storage of an execution result, and a source identifier specifies a physical source in said reorder buffer where an operand is eventually to be found.

9. The processor of claim 8, further comprising:
a data path coupling outputs of said execution units to said reorder buffer; and
a routing block to route each execution result corresponding to a destination identifier that matches one of said source identifiers to an appropriate port of said reservation station for an operand corresponding to said one of said source identifiers, wherein said execution result is retrieved from said data path so that said register alias table and allocation unit does not need to allocate a read port of said reorder buffer for said reservation station to read said execution result.

10. The processor of claim 9, wherein said data path includes a delay buffer, and said routing block is to route said execution result from said delay buffer to said appropriate port.

11. The processor of claim 10, wherein said destination identifiers are stored in said delay buffer together with said execution results, and said matching block is to compare said destination identifiers from locations in said delay buffer to said source identifiers.

12. The processor of claim 9, wherein said reservation station is to receive said execution result via said one of said plurality of ports and to store said execution result, and wherein said register file is to receive said execution result and to store said execution result.

13. The processor of claim 12, wherein said reservation station is to receive said execution result via said one of said plurality of ports and to store said execution result while said register file stores said execution result.

14. An apparatus comprising a processor, the processor including:
a reservation station;
a register alias table and allocation unit to issue micro-operations to said reservation station and to provide source identifiers of one or more operands of said micro-operations to said reservation station;
one or more execution units to provide execution results and corresponding destination identifiers; and
a reorder buffer including a matching block to compare destination identifiers of one or more of said execution results that are not yet stored in any register file of said reorder buffer to said source identifiers,
wherein a destination identifier specifies a physical destination in said reorder buffer that is allocated for storage of an execution result, and a source identifier specifies a physical source in said reorder buffer where an operand is eventually to be found.

15. The apparatus of claim 14, wherein the processor further comprises:
a data path coupling outputs of said execution units to said reorder buffer; and
a routing block to route each execution result corresponding to a destination identifier that matches one of said source identifiers to an appropriate port of said reservation station for an operand corresponding to said one of said source identifiers, wherein said execution result is retrieved from said data path so that said register alias table and allocation unit does not need to allocate a read port of said reorder buffer for said reservation station to read said execution result.

16. The apparatus of claim 15, wherein said data path includes a delay buffer, and said routing block is to route said execution result from said delay buffer to said appropriate port.

17. The apparatus of claim 16, wherein said destination identifiers are stored in said delay buffer together with said execution results, and said matching block is to compare valid of said destination identifiers from locations in said delay buffer to said source identifiers.

18. The apparatus of claim 15, wherein said reservation station is to store said execution result, and wherein said register file is to store said execution result.

19. The apparatus of claim 18, wherein said reservation station is to store said execution result received via said one of said plurality of ports while said register file stores said execution result.

20. The apparatus of claim 14, wherein said apparatus is a computer.

21. The apparatus of claim 14, wherein said apparatus further comprises a voltage monitor.
